(19) United States
(12) Patent Application Publication
(10) Pub. No.: US 2004/0150853 A1
(43) Pub. Date: Aug. 5, 2004

(54) Method, equipment system and computer program system for visually checking a print data flow

(76) Inventors: Albin Stodersching, Munchen (DE); Jorg Schmidt, Munchen (DE); Enrico Thierbach, Munchen (DE)

Correspondence Address: SCHIFF HARDIN, LLP, PATENT DEPARTMENT, 6600 SEARS TOWER, CHICAGO, IL, 60606-6473, US

(21) Appl. No.: 10/477,472

(22) PCT Filed: May 14, 2002
(86) PCT No.: PCT/EP02/05296

(30) Foreign Application Priority Data
May 14, 2001 (DE) 101 23 411.2

(51) Int. Cl. G06F 15/00; G06F 3/12

(52) U.S. Cl. 358/1.13; 358/1.15

(57) ABSTRACT

The invention relates to a method, a system or a computer program for visually checking a print data flow, wherein said print data flow is subjected to a first raster process for print output and to a second raster process for visual checking. The same raster method is used in both raster processes.

The invention concerns a method, a device system and a computer program system to visually check and control a print data stream.

Such print data streams are known in a plurality of print data languages. For example, in typical office environments the print data format Printer, Language [sic] (PCL) is common. This is a prevalent output format for desktop publishing system. On the other hand, the Advanced Function Presentation (AFP) print data format is rather common in a print production environment (for example in computer electronic data processing centers). Due to increasing networking and the porting connected therewith of print data or, respectively, document data between different computer systems and their application programs, the task ensues ever more frequently to process the most different print data streams in a document output system or, respectively, print system.

From the publication “The World of Printers”, Dr. Gerd Goldmann (Hsrg.), Océ Printing Systems GmbH, Poing, 5th edition (November 2000) ISBN 3-00-001-081-5, what is known as a PRISMApro server system, with which a plurality of print data streams can be processed on an individual print production control platform, is known in chapter 11 on the pages 11-1 through 11-20.

To generate and monitor documents, what is known as the What you see is what you get principle (WYSIWYG) is known. Documents are thereby generated according to predetermined conventions, with the goal, upon generation of the documents, to already achieve a representation of the documents that corresponds to the later reproduction of the document on a recording medium.

In complex print production systems, the WYSIWYG objective in particular then runs up against limits when document data must be processed in a plurality of language variants. Additionally, production print systems possess a plurality of setting possibilities that can influence the respective detailed representation on the output medium.

In DE 629 29 112 T2, a device and a method are specified in which the WYSIWYG concept is used.

Methods and devices are known from Pat. No. 5,940,584 and from WO 99/12 337 A2 with which print data can be accepted pixel-perfect into an archiving system. The print data are thereby converted from the print data format into a pixel-based (rastered) image format, and these converted data are alternatively supplied to the point-by-point control unit of the printer and/or to an archiving system. It is therefore possible with this system to file a pixel-perfect copy of printed data in an archive storage. In addition to the image data, indexing data are formed which are stored in the archiving system together with the image data in order to enable a later retrieval of the documents in the archive system.

A method and a system to implement a printing area correction comes from DE 199 21 120 A1, which corresponds to WO 00/68877 A1. Print data are thereby provided to the printer in a logical page sequence corresponding to at least one signature. At least one parameter of the recording medium, for example of the paper on which the data are printed, is determined that is relevant for the position of the print image on the recording medium folded per signature. For example, the weight and or the thickness of the paper is determined. Dependent on this parameter, a position correction of the pages is implemented before the printing, such that the print images of successive pages of the finished signature are in registration. The shifting of the print image due to the folding of the paper before the printing is thus corrected.

DE 100 17 928.2 specifies a method to process print data, in that the print data are displayed on a display device before the pritting [sic] (Preview). A test means that can be moved on the display device is hereby shown for the print data. The test means is, for example, a cross-hairs. With the aid of this testing means, the registration or, respectively, registration containment are tested. For this, the test means is positioned and fixed at a position predetermined via the edge of the shown print data. The next or, respectively, succeeding pages are then displayed, and their position established relative to the fixed test means. Given a discrepancy, the print images can be correspondingly shifted, such that they are in register or, respectively, registration-contained.

From the publication “Applicationbased [sic] printer generated print preview, IBM Technical Disclosure Bulletin, April 2001, page 708, Nr. 207, a method is known in which print data are supplied to a print device and a raster image processor located therein for rastering. The raster data (bitmap) thereby generated are transmitted via an intermediary step (print preview listener) to an inspection device (Application print preview listener), and can there by inspected by an operator.

From U.S. Pat. No. 5,615,314 A, a method and a print system are specified in which incorrect image regions are corrected in the course of the rastering process.

A method to check the registration containment of two pages of a printed recording medium to produce a printing plate arises from U.S. Pat. No. 5,625,766. An image file to be imaged on the printing plate is hereby first rastered with a raster method that is differs only by a lower resolution from the raster method with which the image file is rastered to generate the printing plate. This image file rastered with lower resolution is shown on a monitor to check the print image. It is hereby also possible that the image data of the front and back side of an recording medium to be printed are overlaid on one another on the monitor, such that the registration precision of both print images can be checked.

A method and a device for electronic archiving of a computer data stream arises from D2 (WO 99/123337) in which the data stream is analyzed and separated on form data and variable data as well as index data. Form data and variable data are rastered archived [sic] as bit-map files, whereas the index data are stored in coded form, for example ASCII. The files existing in the bit-map can be retrieved by a read device and shown on a computer monitor. They can also be supplied directly to a printer for printing. To raster the data stream, a print controller can be used that is used both to generate a data stream to control a printer and also to generate an archive data stream.

A desktop publishing system is known from D3 (Wo [sic] 89/06396) in which on [sic] an image file generated in a personal computer is rastered into a bit-map and is stored in a bit-map storage. This bit-map is displayed directly on the monitor and output to the printer. It should hereby be ensured that the display on the monitor conforms with the output to the printer.

The publications and patent applications or, respectively, the respective corresponding applications cited above are hereby included via reference in the present specification.

It is the object of the invention to enable the precise visual checking of documents that exist as a print data stream in a print data language.

This object is achieved via the invention specified in the independent claims. Advantageous embodiments of the invention arise from the sub-claims.

The invention is based on the realization that the ability for high-precision visual checking of documents or, respectively, print data streams on an electronic display medium depend in particular on using a display raster process for the preannouncement [sic] that corresponds as precisely as possible to the print raster process. For this, it is in particular provided to implement the display rastering with a raster control whose raster rules coincide exactly with the raster rules of a raster control of the print device. Such a coincidence is achievable with various possibilities: according to a first possibility, exactly the same raster control is used. Such a raster control can, for example, be fashioned as an electronic hardware circuit. The display raster process can then, for example, run on exactly the same electronic circuit, whereby the identity of both raster processes is ensured. However, given use cases in which the electronic raster control of the print raster process is not available, it can also be provided to implement the display raster process by means of a computer program (software) that at least substantially, in particular precisely, follows the calculation rules of the hardware control, and that thus leads to a raster result that fairly precisely corresponds, in particular corresponds pixel-perfect or very precisely, to the raster result achieved with the hardware control.

For a pixel-perfect congruence of both raster processes, it is in particular advantageous to adopt all settings of the print device that influence the raster process in direct and/or indirect effect. Furthermore, it can be provided to use print device-specific settings in order to provide further recording-relevant corrections for a representation of the image effected as true to the original as possible on the final recording medium. For example, it can be provided for a two-sided recording of images onto paper, given a thermal print fixing event in the framework of an electrophotographic recording process, to consider ensuing contraction of the paper in such a way that after the display raster process, a further correction to the rastered display data ensues, just as in the print raster process, before these are displayed.

According to a further aspect of the invention, that can also be viewed as independent of the first aspect of the invention cited above, print data are transmitted to a print data production system in one of many possible different print data languages. There they undergo a display raster process, then are transmitted to a print device for display and checking, and finally for implementation of a print raster process. According to this aspect of the invention, the print data are processed job-by-job, whereby each job processes a plurality of pages and/or transmissions that are combined from different pages. In such a print data production system, a plurality of processing stages and processing possibilities are provided for the document data. For this, in particular indexing data can be inserted into the print data stream, the print data and/or [sic] rastered in the print data languages and, as the case may be, stored with the indexing data, and the processing of a print data job can be controlled with a job processing system.

In a further aspect of the invention, that likewise can be viewed as independent of the previously cited aspects of the invention, print data that are transmitted for a duplex printing on the front side and back side of a recording medium are displayed for simulation and/or checking of the printer result, in particular for checking of the registration containment of the print on the front side and back side of the recording medium, respectively the pertaining data of two pages are displayed together on a recording medium [sic]. The display thereby corresponds precisely to the display on the recording medium, whereby the data of the back side of the recording medium are displayed quasi mirror-inverted on the display medium. To differentiate the data of the back side and the data of the front side in their mutual representation, the respective items of information are characterized differently during their display, in particular with different color.

According to a further aspect of the invention that likewise can be viewed as independent of the previously cited aspects of the invention, the print data are processed job-by-job and page-by-page in a print production system and transmitted to a print device. The current items of page information present at the print device are thereby respectively displayed by means of a monitoring system. With this aspect of the invention, the print production process can follow the display device at almost the exact same time, in all but real time.

For job-by-job processing of print data streams, it is in particular advantageous to provide a possibility to switch between the first operating mode cited above, namely the real-time display of printed pages, and a job-by-job selective second operating mode, via which respectively only predetermined pages (by default the first page) and specific pages of a print job are displayed upon request. In a print production system in which a plurality of printing devices are processed in parallel by a common print job control program, it can thereby also be provided within the display device to switch between different jobs that, as the case may be, are printed on different printing devices, and thus to follow the current production steps on the individual printing devices page-perfect with the full page information.

It is thereby in particular also advantageous to buffer the rastered data belonging to a print job (Job), and to only delete the buffered data by particular request and/or only after a predetermined time limit, for example respectively on the weekend.

The present invention is in particular suitable to check print processes. What are known as waste pages, that ensue when print jobs are printed on a trial basis or when activated print jobs are printed incorrectly for setting reasons, can hereby be prevented. In the print production environment, print preparation time and/or actual print time can thereby be saved. The savings in particular has an effect in the areas of digital high-capacity printing, particularly engraved, in which page-by-page or document-by-document individual print data are printed two-color or multi-color. The invention thereby enables not only the overlaying of raster data on front and back sides on a preview display device, but rather alternatively or additionally the overlaying of rastered color excerpts. Via a corresponding enlargement of multi-colored print data on the display device, such that the basic resolution of the raster is discernable, the color excerpts can be checked with regard to their raster precision or, respectively, overlay quality, and given unacceptable variations new raster processes are activated with changed (corrected) parameters before a transfer printing ensues. This prevents waste.

The invention furthermore allows print data to already be examined online before the printing, and thereby, for example, to check the correct assignment of predetermined form data with individual print data (for example billing data such as addressee, billing number, customer number, etc.). The adaptation of the raster process for the display data to the raster process for the print data thereby enables not only a high-precision conformity of the checking display with the actual printed documents, it is thereby in particular enabled when the control program for the display raster process automatically ensues the settings of the print device selected for the later print process and/or its raster processor [sic].

The invention can in particular be advantageously used in the migration of different document processing systems. It enables data of the most different input formats, that are processable in a print production system, to be monitored pixel-perfect with a display program connected thereto. Since, in the migration of generation and print production control programs to new system environments, the image data must often be converted, errors in the print image can ensue via the migration. Since, with the invention, the rastered image data are monitored, such conversion errors are detected. In addition, the display device for the preview of the rastered image data (that is a PIXEL file in a typical format) can be realized simply in any system environment.

With the invention, print data of different document generation programs (such as, for example, a word processing program, a program to prepare presentations, or applications of different operating systems such as, for example Windows applications and Apple applications, and applications of a mainframe system such as, for example, Océ PRISMA FGL (Forms Generation Layer), for example based on a BS2000 operating system) can be monitored by means of an individual display device, and from this corrections can be derived.

It can hereby be advisable to provide a uniform correction platform with which the corrections undertaken on the screen of the operator are automatically adopted by the document generation program. For this, control commands adapted to the respective document generation program are generated by the correction platform.

Further aspects and advantages of the invention are subsequently specified using some exemplary embodiments and figures.

Thereby shown are:

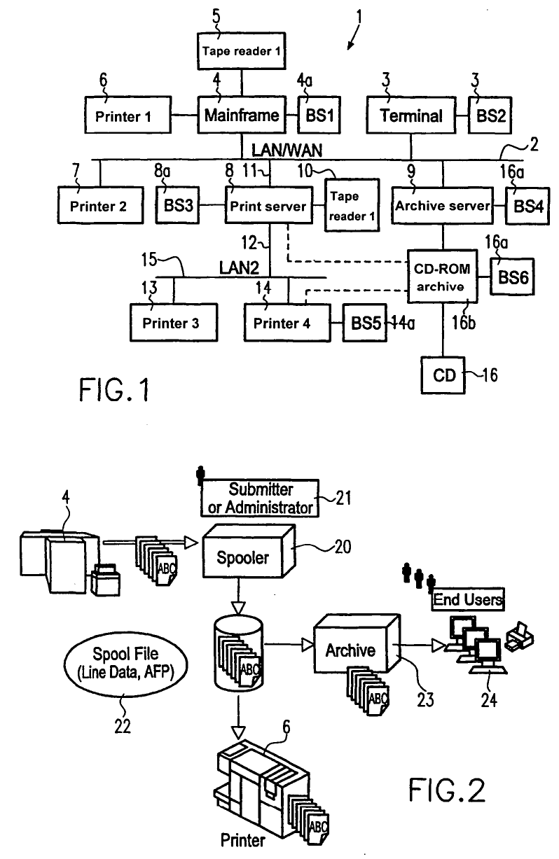

FIG. 1: a print production and archive system,

FIG. 2: a simplified process flow in a print production and archive system,

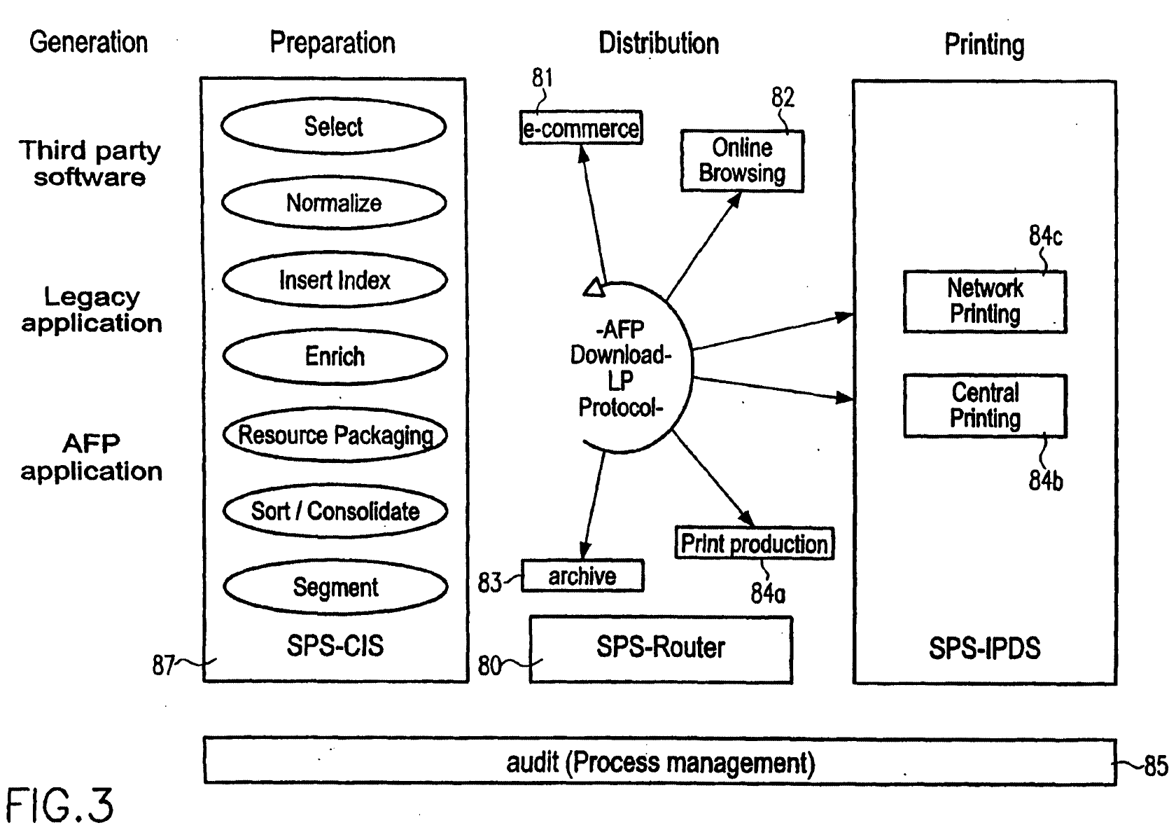

FIG. 3: work flows in a document processing system,. [sic]

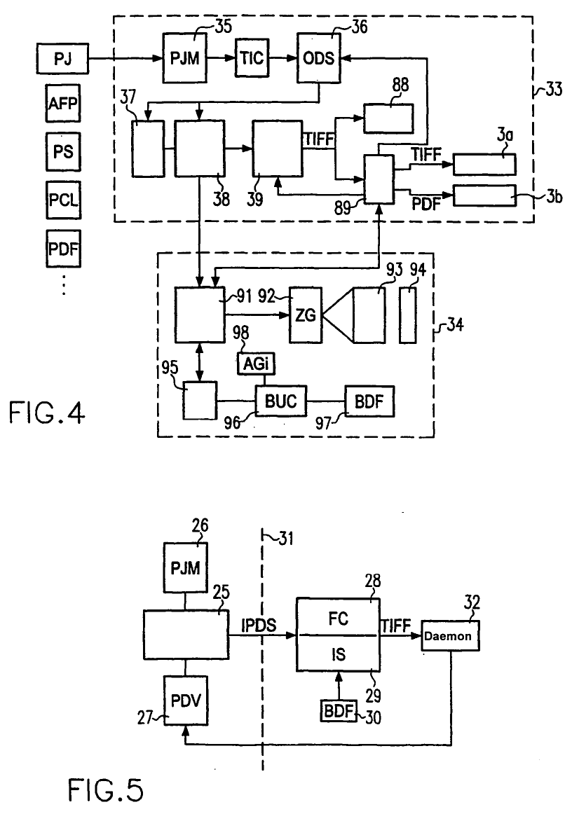

FIG. 4: control components in a print production system,

FIG. 5: program components to control the rastering of display data,

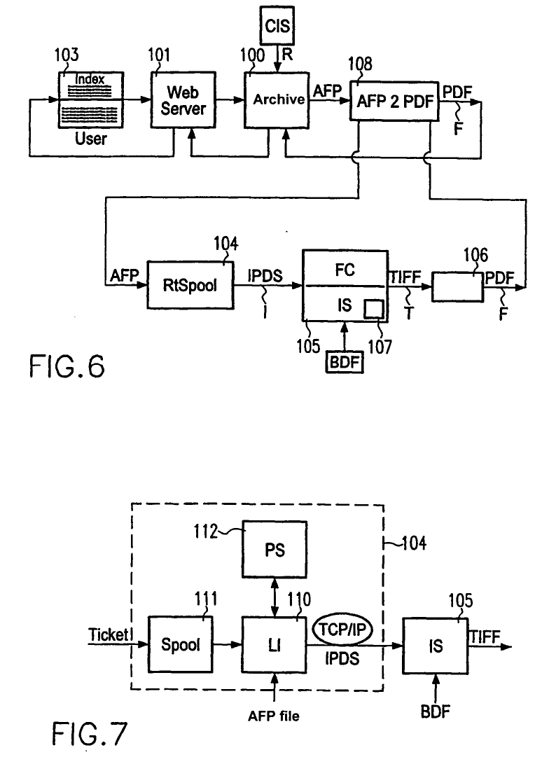

FIG. 6: control components for the rastering of display data from an archive system,

FIG. 7: a detail flow of the process shown in FIG. 6,

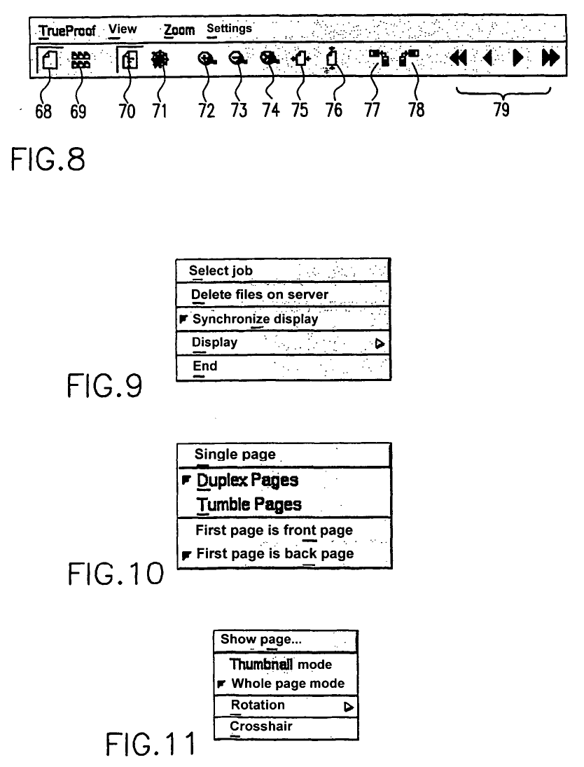

FIG. 8: a main menu in a display program,

FIG. 9: a job-specific sub-menu in a display program,

FIG. 10: a page-specific sub-menu in a display program,

FIG. 11 display-specific setting possibilities,

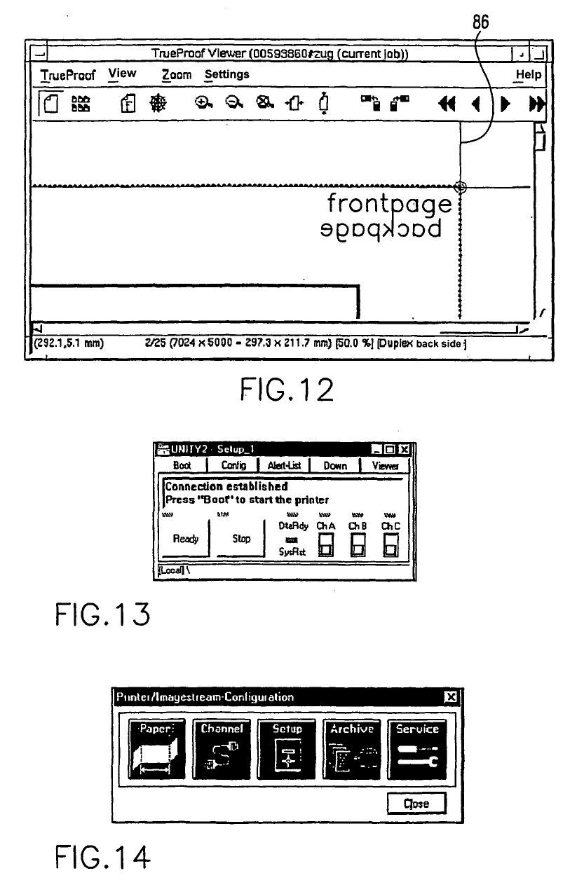

FIG. 12: a display window to check the registration containment of successive print pages,

FIGS. 13-16: printing device-specific setting menus,

FIG. 17: an archive-specific setting menu,

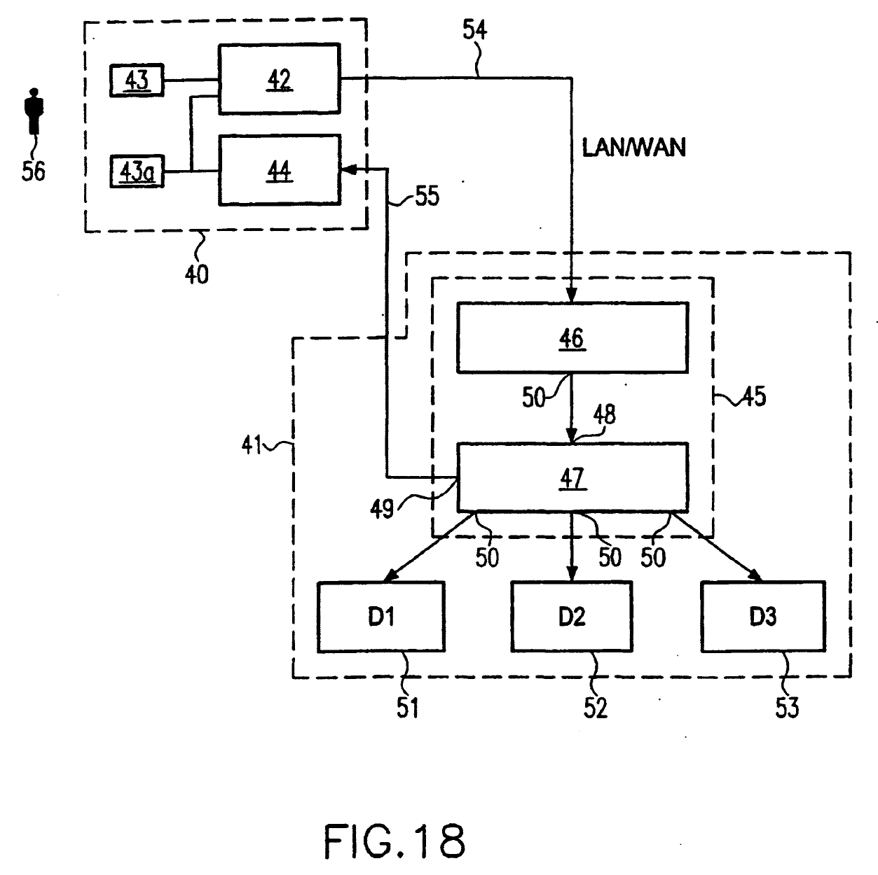

FIG. 18: a schematic assembly of an inventive system to control a print data stream in a block diagram,

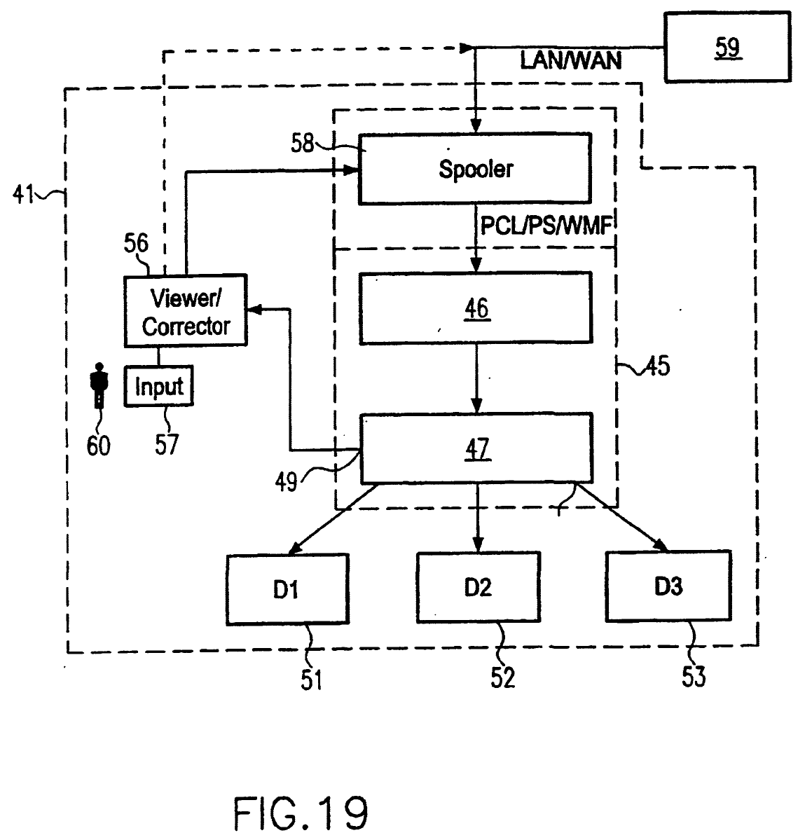

FIG. 19: a schematic assembly of a further inventive system to control a print data stream in a block diagram, and

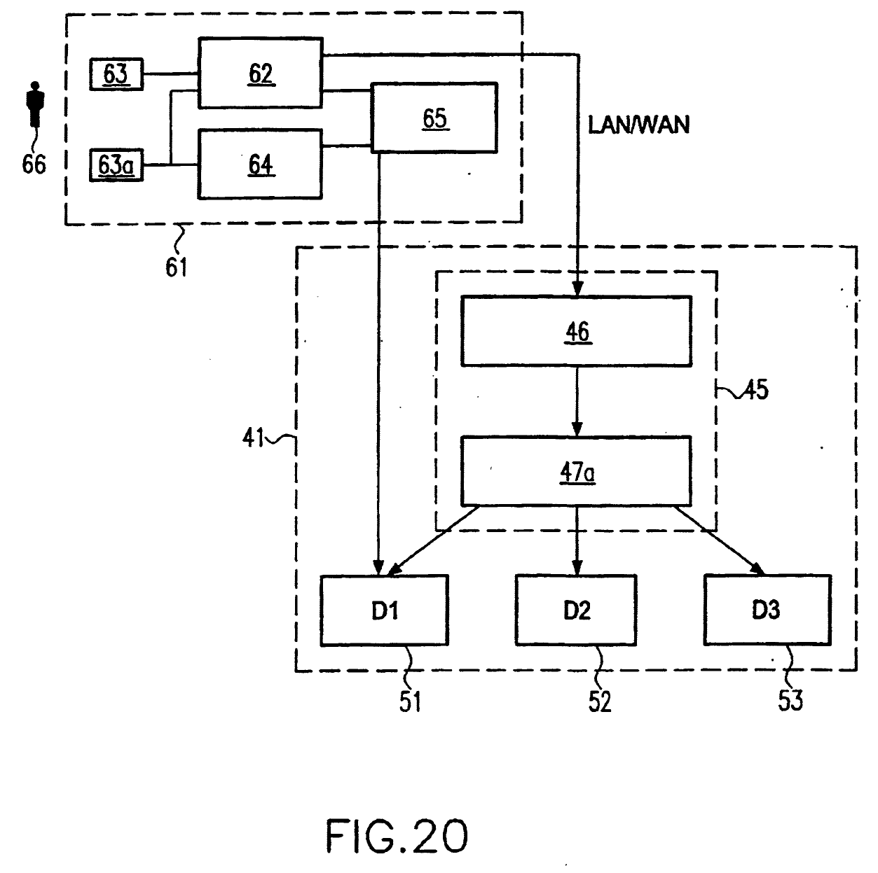

FIG. 20: a schematic assembly of a further inventive system to control a print data stream in a block diagram.

A high-capacity print system 1 is shown in FIG. 1, in which various different system components over [sic] a data network 2, which can be a local network (Local Area Network, LAN) or also a larger network (Wide Area Network, WAN). At least one client terminal 3, on which print jobs can be generated, is attached to the network 2. The terminal 3 is a known computer (for example personal computer PC) with connected monitor 3a.

The print jobs can optionally also be generated on a main computer (main frame [sic]) 4 and/or data can be inserted into the print job from the main frame 4. The main frame 4 of the computer center is controlled via a suitable operating system control such as MVS, BS2000 or VSE. On the main frame 4, control functions and displays via the monitor 4a connected thereto can ensue. Additionally, a tape reader device 5 as well as a first high-capacity printer 6 are directly connected to the main computer 4 (main frame).

Additionally, a second printer 7, a print server 8 as well as an archive server 9 are connected to the data network 2. The print server 8 in turn is connected with a second tape reader device 10 as well as a monitor 8a. In addition to the connection 11 between the print server 8 and the main data net-work [sic] 2, the print server is connected via the connection 12 with a second local network 15, to which further printers 13, 14 are connected. The print server 8 as well as the printer 14 can optionally be connected with a system 16b for production of archive storage 16, for example with a write device for optical storage discs (CD-ROM, DVD), magnetic storage discs (magnetic disks), tape storage, cassette storage, “write once read many” (WORM) devices, or for other non-erasable storage. However, the archive system 16 works mainly together with the archive server 9. Via additional monitors 9a, 16a and 14 a [sic], the respective devices 9, 16 and 14 connected with them can be operated, and optionally connections to other components connected to the network 2 can also be established.

FIG. 2 shows basic components for archiving. The data stream output by the host computer 4 is gathered in a spooler 20, whereby parameters of the spooler 20 are given or, respectively, provided. The spooler 20 is installed as a software program in the print server 8 or in the host computer 4. It uses various devices (interfaces, storage, bus system) of the server 8 and/or of the host computer 4. The spooler 20 then outputs a spool file 22 and supplies it to the printer 6 and/or to an archiving component 23. From there, the individual documents can be displayed on workstations 24 or printed out in turn.

The spool file can be transmitted in various data formats, for example in the line data format (line data) or in the AFP format. In the course of the archiving, the documents are stored with all necessary information, such that at any time it can be recalled again and duplicated in its original print quality, even at a later point in time when the computer system environment or the print environment has changed. The workstations 24 can in particular access the archive component 23 via a network, for example also via the Internet, whereby the access thereby can be used via known browser technologies such as the browser Microsoft Internet Explorer® or Netscape Communicator®.

In FIG. 3, four basic stages are shown to process document data in a document processing system with attached print system. In a first phase (Generation), document data are generated or, respectively, read into the document data system. This can ensue in three different manners, namely on the one hand via generation of a document with an application software (third party software), for example via a word processing system, a graphic image generation system, an office scanner that scans paper documents, or the like. In a second application (legacy application), existing document data can exist in the form of an AFP data stream (AFP application) or a format not specified further (legacy application). In a second processing stage “preparation”, the respective data are processed for the respective output steps (distribution printing). For this, a control program (SPS) serves with which the three processing stages can controls [sic] coordinated with one another in the form of a production process. It comprises the three components for the three processing steps. In the first component 45 (SPS-CIS), the incoming data streams are normalized to a uniform format (AFP), the data are indexed, augmented with control data, resource data are generated, a resorting/consolidation of the data stream are [sic] effected, and finally the data streams are output-specifically segmented, such that the subsequent output steps (distribution, printing) can be implemented with higher speed.

A distribution module “SPS-Rooter” 80 serves to distribute the print data to various output channels. With the distribution module 80, the data can be alternatively supplied to systems for electronic transmission (for example per e-mail) in an e-commerce module 81, to a display module “Online-browsing” 82, to an archiving system 83, or to print production systems 84a, 84b, 84c. In particular, special print systems can thereby [sic] for output of the print data in a network (in particular a network of print devices connected via a network) 84c or via a local central print system 84b located at a specific site. The process stages of the processing, the distribution and (as the case may be) of the printing are monitored by monitoring modules 85.

FIG. 4 shows, schematically simplified, the structure of the control components in a print production system. The print production system comprises a control system 33 and a printer 34. The control system 33 comprises a print job manager 35 that processes incoming print jobs of different formats (AFP, PS, PCL, PDF) and provides a job ticket (.TIC) in which the corollary data necessary for the execution of the print job are stored. The print job manager 35 directs the print jobs to a control module 36 (ODS: Order Distribution System) that forwards the print jobs to a print production program 37 or a print data stream converter 38.

The print data converted by the print data stream converter 38 into the IPDS print data stream are supplied to a raster device 39 in which they are rastered and converted into a PIXEL file, which is, for example, in the TIFF format. The PIXEL file can be stored in an archive 88 or displayed in a display module 89 by means of a display program 90a, 90b. The display module is a software module that either forwards the PIXEL file unchanged in the TIFF format to the display program 90a, or converts it into another format (for example PDF) and (as the case may be) with regard to further parameters such as, for example, the offset dependent on the folding, the paper shrinkage [sic], forwards it to the display program 90b.

This display module 89 comprises connections to control module 36 and to the raster device 39 that schematically show that an operator can take corrective action on the print data by viewing the PIXEL files shown by means of the display programs 90a and 90b.

In the printer 34 are [sic] a raster device 91 that can either receive a print data stream directly from the print data stream converter 38 or can receive a print data stream from the display module. The raster device 91 rasters the print data stream and forwards it to a character generator 91 that, for example, comprises an LED comb and exposes a photoconductor drum 93 corresponding to the rastered print data. A paper sheet 94 is printed with the aid of the exposed photoconductor drum 93.

The rastering device can access a data storage 95 in which the print parameters of the printer 34 are stored. These print parameters can be changed by a BUC controller 96 (Basic Unit Controller) that is connected with a control panel 97 and units 98, such as for example the paper feed devices.

The raster device 39 of the control system 33 is a functionally identical replica of the raster device 91 of the printer 34. It is hereby ensured that the representation generated with the display programs 90a, 90b is identical to a potential printout on paper.

FIG. 5 shows schematically program components of an exemplary embodiment of the invention with a print production program 25 to generate an IPDS steam, a pull-down menu 26, a display program 27, an FC module 28 (Functional Code), and an IS module 29 (ImageStream). The FC module 28 and the IS module 29 are stored in a control device of a printer, whereby settings in the modules 28, 29 can be changed via a control panel 30 on the printer. The program components 25, 26, 27 are stored on a computer that is connected with the printer via a data line. In FIG. 5, the area between the printer and the computer is separated by a dashed line.

The FC module comprises the rules to raster a print data stream. The rastered print data represent the pattern with which the exposure elements of the pritter [sic] (that are, as a rule, light-emitting diodes) are controlled. The IS module comprises a function with which the rastered printing form can be converted into a PIXEL file, for example into the TIFF format. These PIXEL files are used to archive the printed documents. This is specified in EP 0 749 659 B1 (corresponds to U.S. Pat. No. 5,940,584). EP 0 749 659 B1 and U.S. Pat. No. 5,940,584 are included in the present specification by reference.

Additionally, a program control section, designated as a daemon 32, is provided that is linked to the FC module, with which a PIXEL file is transmitted to the display program 27.

The operating mode of these program components are subsequently explained in detail. A print data stream in the IPDS format is generated and transmitted to the printer with the print production program 25. This print data stream is rastered by the FC module into a format suitable to control the printer unit and stored in a control file. The control file is converted by the IS module 29 into a PIXEL file. This PIXEL file is transmitted by the daemon to the display program and displayed by this on a display device. An operator can now effect corrections to the print data based on the rastered print data shown on the print production program 25.

It is shown in FIGS. 6 and 7 how print data that are stored in a central archive storage 100 of a print production system in the print data format AFP (Advanced Function Presentation) are converted into a PDF (Portable Document Format) print data stream and are likewise buffered in the archive. Variable AFP print data V are thereby in particular imported into the archive storage 100 via the web server 101 in the course of the processing of a print task (print job) during a print production process. AFP inline resource data are thereby imported from the conversion, indexing and sorting system CIS 102 into the archive storage 100, such that the variable data and the resource data can be merged into the complete AFP data stream P. However, they can also be imported from an external archive storage (for example from a tape storage or a CD-ROM archive)as data stream A.

Further details to generate such an AFP data stream are to be learned from the German patent application Nr. 100 17 785.9, whose content is hereby included by reference in the present specification.

The variable data V are imported into the archive storage via the web server 101 in the course of a print production process. The web server 101 is thereby operated via a user interface 103 (hardware and/or software) by means of a network connection (LAN, WAN).

The AFP print data stream P is converted into a PDF print data stream in the conversion module 108 and likewise supplied to the archive storage 100.

The complete AFP print data P are first converted into an Intelligent Printer Data Stream (IPDS) print data stream I in the conversion module 108 via the spooling module 104 (RtSpool). This data stream I is then converted in the conversion module 105 (which corresponds to the modules 28, 29 (FC/IS) shown in FIG. 5) into a TIFF data stream T. The conversion module 105 can thus in turn be fashioned as an SRA controller with corresponding hardware modules and/or software modules (Functional Code, FC). The calculation rules to generate the rastered image thereby correspond precisely to the calculation rules in a print device. Printer settings, that in particular were effected via a control panel (BDF) on the print device, also enter here again into the raster rules for the electronically generated image.

In addition to conversion of the IPDS data into TIFF data, further corrections can be effected for the TIFF image file by a recording-process correction module 107 integrated into the IS module or connected in series with it, via which the further influences that can operate during the recording process of the image data onto a recording medium are considered. For example, in the framework of an electrophotographic process with thermal print fixing, a paper shrinkage given printing of toner onto paper can thereby be corrected. The electronic image shown for checking thereby corresponds even more precisely to the image finally generated on the paper.

The TIFF data stream T is subsequently converted into a PDF data stream F in a PDF converter 106.

Both converters 104 and 105 are again shown in somewhat more detail in FIG. 7. The AFP data F are supplied in the conversion module 104 to a platform-dependent interface 110 (LI: Logical Interface) that also cooperates with another data source 111 (Spool). In particular print job corollary data (ticket data) are provided via the spool module 111. A platform-independent print server system 112 is placed on the interface 110 that effects the actual conversion of different print data formats such as, for example, AFP, PS, PCL, PDF into a uniform format (IPDS).

FIG. 18 shows an exemplary embodiment of a device system to visually check a print data stream.

This device system comprises a document generation and checking system 40 and a print production system 41.

The document generation and checking system 40 comprises a document generation device 42, and input device 43 and a display device 44 for visualization of a print data stream. This document generation and checking system 40 is, for example, represent by a personal computer, whereby the document generation device 42 is a computer program with which print data to be printed can be generated, such as a word processing system, the input device 42 is the keyboard of the personal computer, and the display device 44 is a computer program to display image information of a predetermined format, such as for example TIFF or PDF. Basically, a commercial program, such as, for example, Acrobat Reader® by Adobe, can be used for this.

The document generation device 42 and the display device 44 can show the print data on a monitor 43a.

The document generation device 42 and the display device 44 can also be fashioned via a single computer program that is suitable both to generate data to be printed and to represent rastered image information. However, the use of such a separate program, specifically fashioned for the inventive method, to display the rastered image information is preferred.

The print production system 41 comprises a print server 45. To simplify the graphical representation, from the print server 45 only a print data stream converter 46 and a rastering device 47 to raster image data are shown.

The print data stream converter 46 converts the print data streams incoming in different formats (PCL, PS, WMF) into a uniform print data stream (IPDS: Intelligent Print Data Stream) that is supplied to the rastering device 47.

This print data stream is rastered by the rastering device 47. In the rastering of the image data, these are converted or, respectively, dithered into a semitone pattern. Different methods are known for this. These are also dependent on the printer with which they should be printed, and in particular on its resolution and printing type (monochrome, multi-color, single-level dithers, multi-level dithers). A suitable rastering device is, for example, the SRA controller specified in “Das Druckerbuch”, Océ Printing Systems GnbH, edition 4a, May 1999, ISBN 3-00-001019-X in chapter 10. Substantial components of this SRA controller are also specified in the U.S. Pat. No. 5,012,434 and in the international patent application WO 00/22537 A1. These documents are included by reference in the present specification.

The rastering device 47 comprises an input 48 to acquire the image data to be rastered and two outputs 49, 50 to output the rastered image data. The output 49 is connected with the display device 44 and the output 50 is connected with printers 51-53.

The document generation and checking system 40 and the print production system 41 are physically connected with a data line that can be part of a local network LAN or an intersite network WAN. In FIG. 18, for simplicity only the data stream 54 from the document generation device 42 to the print data stream converter 46 and the data stream 55 from the rastering device 47 to display device 44 are shown.

The functionality of the inventive device system according to 18 is subsequently explained.

With the aid of the document generation device 42, an operator 56 generates a document file to be printed. This document file is generated by the document generation device 42 in a print file in the format PCL, PostScript (PS), Windows Meta Format (WMF) or another arbitrary print format and transmitted to the print data stream converter 46. The print data stream converter converts the incoming print data stream into a print data stream with uniform format and forwards it to the rastering device 47. Here the document file is rastered and converted in a check file into a standard format of image files such as, for example, TIFF or PDF. In a simple embodiment of the invention, this conversion can comprise only a conversion of the corresponding formats. However, in a preferred embodiment the image data are revised according to requirement of a predetermined physical print appearance. Thus the paper thickness and folding can be considered in the production of a bound print copy, whereby the print image is differently offset on the individual pages. On the other hand, a shrinkage of the paper in the print event can be correspondingly corrected.

This check file is transmitted to the display device 44 and can be viewed by the operator 56. Since the check file is derived from the rastered image data, its content is identical to a physical printout based on this rastered image data. The operator thus receives a complete WYSIWYG representation of the potential printout on the display device 44. This is thereby achieved since the check file is based on the rastered image data that already comprises all printer-specific attributes., such that the physical printout of this data causes no or only extremely small changes.

If the representation on the display device 44 corresponds to the requirements of the operator, he inputs on the input device 43 an enable instruction that is forwarded to the rastering device 47. Based on this enable instruction, the corresponding rastered image da [sic] are transmitted to a printer 51, 52, 53, where the print data stream is printed on a recording medium, which as a rule is a sheet of paper.

In the framework of the invention, it is self-evidently possible to connect a plurality of document generation and checking system [sic] 40 with a print production system 41, whereby the document generation and checking systems 40 can generate print data in the most different formats, insofar as they can be converted by the print data stream converter 46.

FIG. 19 shows a further exemplary embodiment of an inventive device system.

This device system likewise comprises a print production system 41 with a print server 45 and three printers 51-53. The print server 45 comprises a rastering device 47 and a print data stream converter 46 and possesses the same functionality as the exemplary embodiment shown in FIG. 18. However, the output 49 of the rastering device 47 is connected with a display device 56 that is part of the print production system 41. An input device 57 is connected to the display device 56.

The print production system 41 comprises a spooler device 58 that serves to buffer document files. The spooler device 58 is connected with one or more document generation devices 59 via a local network LAN or an intersite network WAN. Furthermore, the spooler device 58 comprises a connection to the display device 56.

The functionality of the device system shown in FIG. 19 is subsequently explained.

A document file generated by the document generation device 59 is first buffered in the spooler device 58 and then forwarded by the spooler device 58 to the print data stream converter 46. The print data stream converter 46 converts the document files incoming in different formats into a uniform print data stream.

This print data stream is rastered by the rastering device 47 and converted in a check file into a standard format of image files such as, for example, TIFF or PDF. This check file is transmitted to the display device 56 and can be viewed by an operator 60 of the print production system 41.

The operator can detect errors in the representation of the check file, whereby via an input on the input device 57 he can correct specific errors such as, for example, variations in the registration. A corresponding correction instruction is forwarded to the spooler device 58, according to the requirement of which the buffered document file is corrected. It is then newly converted and rastered and converted into a check file and displayed on the display device 56, until the operator gives an enable instruction. Upon this enable instruction, the rastered image data are supplied to any of the three printers 51-53 and printed.

If, upon viewing the check file, the operator determines and error that he can not independently remedy himself, such as, for example, an apparent falsity in the content of a text, he can this, in the case that the display device is connected to the local or intersite network, transmit a corresponding notification for an operator of the document generation device 59 and indicate this error to him.

FIG. 20 shows a further exemplary embodiment of an inventive device system. This comprises a conventional print production system 41 with a print server 45 and three printers 51-53. The print server is provided with a rastering device 47a and a print data stream converter 46, whereby this rastering device 47a is not fashioned to generate a check file.

This print production system 41 is connected with a document generation and checking system 61 via a local network LAN or an intersite network WAN. This document generation and checking system 61 in turn comprises a document generation device 62, an input device 63, a display device 64, and a monitor 63a. The document generation device 62 and the display device 64 are connected with a rastering simulation module 65.

The rastering simulation module 65 is a hardware circuit that reproduces the unit from the print data stream converter 46 and the rastering device 47a of the print production system 41 and rasters the document files generated by the document generation device in a manner identical to the rastering device 47a, and converts it in a check file in a standard format of image files, such as, for example, TIFF or PDF. This check file is shown on the monitor 43a by means of the display device 64. An operator 66 of the rastering simulation module 65 can then detect errors using the WYSIWYG representation on the monitor 63a and correct them via a corresponding input. Not until the operator has checked the document file does he transmit it via the network to the print production system on which it is printed out.

In this exemplary embodiment, the print data rastered by the rastering simulation module 65 can be directly supplied to one of the printer 51 [sic] (FIG. 20).

In the framework of the invention, it is also possible to fashion the rastering simulation module 65 as a computer program module.

In contrast to the exemplary embodiments shown in FIGS. 18 and 19, the embodiment with a rastering simulation module 65 exhibits the advantage that the generation of the check file ensues on the document generation and checking system 61, whereby the check file is made available to the operator substantially faster. However, since the rastering device 46 is hereby simulated, it is to be heeded that an exact imaging of the rastering device 46 with all settings of the printer connected with it is always present. This is, for example, accomplished via regular queries of the status of the rastering device 46 and the connected printers 51-53.

In contrast, it is advantageous in the embodiments according to FIGS. 18 and 19 that the actual settings inherent to the system for the rastering are always present to fashion the check file.

Using menu sections shown in the FIG. 8 through 17 of a computer program to visually check and control a print data stream, some substantial operating steps and functions of this computer program is [sic] subsequently explained. This computer program corresponds to the embodiment according to FIG. 20, whereby the rastering simulation module is realized as a software module. The check files generated with the rastering simulation module are used both for the inventive preview and the a storage in an archive.

FIG. 8 shows a main menu with the following icons:

68 display individual page

69 display thumbnails

70 translucent mode on/off

71 erase marks

72 zoom in

73 zoom out

74 display at 100%

75 adjust page horizontal

76 adjust page vertical

77 rotate 90° counterclockwise

78 rotate 90° clockwise

79 change pages (first page, preceding page, next page, last page)

What is known as a translucent mode can be activated with the icon 70. Given a duplex print, the back side is hereby shown simultaneously with the front side (FIG. 12). Given a simplex print, the simplex page or, respectively, simplex pages following a current page are shown.

Additionally, a moveable test means 86 is shown on the display device. In the present exemplary embodiment, the test means is a crosshair 86. With the aid of this crosshair 86, the registration or, respectively, registration containment is checked. For this, the crosshair 86 is positioned and fixed at a position predetermined by the edge of the displayed print data. The positioning of the crosshair ensues via positioning of a mouse cursor given a pressed Shift key and pressing the left mouse button.

The back side (duplex print) is then displayed, and its position is established relative to the fixed test means. This ensues in that the crosshair positions and fixes on the edge of the back side. The shift path (Shift) between both of these positions is numerically output and can be used by the operator to correct the registration.

The crosshair can also be maintained in a further check file, such that a comparison possibility is achieved across a plurality of files.

DE 100 17 928.2 specifies a method to correct print data in a preview with a corresponding test means. The content of this patent application is included by reference in the present specification.

In the method explained above to generate the check file, a correction step is preferably implemented that takes into account the shifting of the print image du [sic] to the folding of the recording medium and/or the paper shrinkage, and that correspondingly shifts the print image in the check file.

The following sub-menus are listed in the main menu (FIG. 8):

TrueProof

View

Zoom

Settings

The sub-menu TrueProof (FIG. 9) comprises the following functions:

Job selection

Delete files on the server

Synchronize display

Display

End

A specific print job can be selected and displayed via the function “Job selection”. Only the print jobs that are stored on a corresponding server can be selected.

With the function “Delete files on the server”, marked stored print jobs can be deleted from the TrueProof server.

With the function “Synchronize display”, a mode is set with which the rastered pages of the current job are continuously displayed. The option “Synchronize display is activated in the default setting.

The option “View” opens a further sub-menu (FIG. 10) with which the individual pages can be displayed in the page layouts simplex, duplex and tumble [sic]. Additionally, the user can select whether he wants to view the first page as a front side or as a back side.

The setting “First page front or back side” is necessary since the display device receives the pages transmitted without information about front or back side.

A selected option is valid for the entire job. Should this internally feature a change, such as, for example, miplex (layout change simplex/duplex or tumble or vice versa), the setting “First page front or back side” must be correspondingly effected.

The individual pages can be shown with translucent back side or, respectively given simplex, with the next simplex page on the back side.

With the function “End”, the window of the display device is closed.

The options of the page representation can be affected via the menu View (FIG. 11).

“Show Page”

With this option, a specific page can be selected for display.

“Thumbnail Mode”

All pages of the document are provided as an overview in the thumbnail mode.

“Whole Page Mode”

In whole page mode, a selected page is shown. In this mode, the selection of the viewing options (for example zooming, rotation) is unlocked.

“Rotation”

The individual pages can be shown in 90° steps. If a new job is loaded, the original position of the page is displayed.

“Crosshair”

In the active state, a crosshair is placed on the representation. With it, the position of individual raster points can be determined. The position values are output in a status line.

Before a job can be transmitted for print servers, in which the visual pre-check should be possible, the corresponding printer must be configured and booted.

An control panel (FIG. 13) can be opened. The configuration of a printer is effected in this control panel via the menu ‘Configuration’. The boot event must not be directly preceded with the desired emulation. In principle, settings can only be effected in the ‘NOT READY’ state and/or in the Offline state (channel Ch A inactive). All parameter settings can be accepted in the status ‘READY’.

The specifications for paper, channel, setup and Imagestream archive are effected with the control panel shown in FIG. 14. Specifications set once can be stored in a setup.

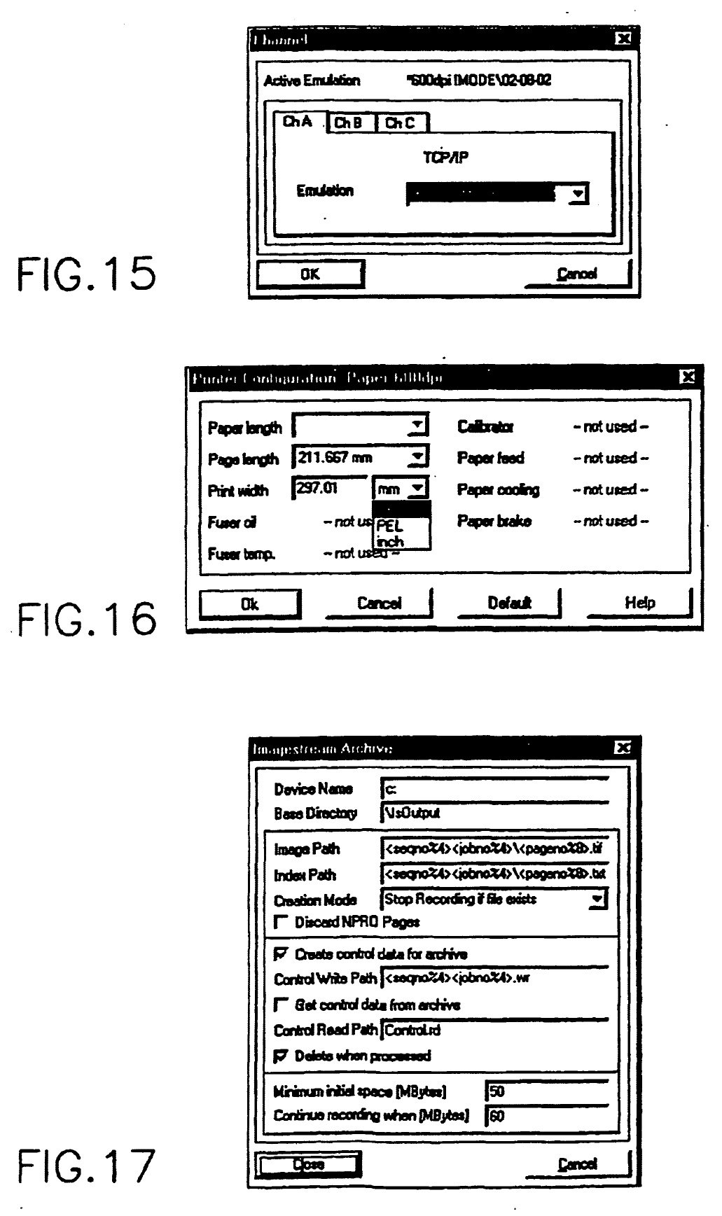

Settings of the emulation can be effected with the control panel shown in FIG. 15. They are always associated with the channel A. As a printer emulation, the I and PCL modes for 240 dpi, 300 dpi and 600 dpi are available.

The emulation set and present after a boot event is displayed under ‘Active Emulation’. If changes were implemented that assume another emulation, the boot request “Please boot the controller” is output. If the emulation is changed, a printer boot must consequently be implemented.

The paper format can be set with the control panel shown in FIG. 16. In the setting of the paper size, it must be considered that the printable page width is specified. This means that given a continuous paper with hole margin, 1 inch must be subtracted from the total width.

The paper format specification can be given in mm, PEL or inches. The selection ensues via marking of the corresponding unit. The page length can be selected in ⅙-inch steps, independent of the set unit. The print area width Print width can be adapted to the required factors. The specifications in Pels concerns the set emulation setting. The set values are adopted with OK.

Settings of an “Imagestream Archive” can be effected with the control panel shown in FIG. 17. The setting parameters are available after a boot of the printer and can be modified. After a modification, these are available after a restart of the computer program system for visual checking and control of a print data stream.

In the normal case, no settings need to be effected in the control panel shown in FIG. 17. In the case that, for the storage of the output files, another fixed disk (partition) should be used, the corresponding specification must be made in the field Device Name and/or Base Directory. The field “Minimum Initial Space” defines the limit value, at the under-run of which the rastering simulation module is stopped. The field “Continue recording when” defines the threshold at which the recording is again continued. When the level is located between both values, the level is displayed in the system panel in the check. When enough space is again present on the archive drive, [sic] rastering simulation module is automatically resumed again.

Reference List

1 high-capacity print system

2 data network

3 terminal

3a monitor

4 main frame

4a monitor

5 tape reading device

6 high-capacity printer

7 printer

8 print server

8a monitor

9 archive server

9a monitor

10 tape reading device

11 connection

12 connection

13 printer

14 printer

14a monitor

15 local network

16 archive storage

16a monitor

20 spooler

21 administrator unit

22 spool file

23 archiving components

24 workstation

25 print production program

26 print job manager

27 display program

28 fc module

29 is module

30 control panel

31 line

32 daemon

33 control system

34 printer

35 print job manager

36 control module

37 print production program

38 print data stream converter

39 raster device

40 document generation and checking system

41 print production system

42 document generation device

43 input device

44 display device

45 print server

46 print data stream converter

47 raster device

48 input

49 output

50 output

51 printer

52 printer

53 printer

54 data stream

55 data stream

56 display device

57 input device

58 spooler device

59 document generation device

60 operator

61 document generation and checking system

62 document generation device

63 input device

64 display device

65 rastering simulation module

66 operator

67 main menu

68 display individual page

69 display thumbnails

70 translucent mode on/off

71 erase marks

72 zoom in

73 zoom out

74 display at 100%

75 adjust page horizontal

76 adjust page vertical

77 rotate 90° counterclockwise

78 rotate 90° clockwise

79 change pages

80 distribution module

81 e-commerce module

82 display module

83 archiving module

84a print production system

84b print production system

84c print production system

85 monitoring module

86 test means

87 first component

88 archive

89 display module

90a display program

90b display program

91 raster device

92 character generator

93 photoconductor drum

94 paper sheet

95 data storage

96 buc controller

97 control panel

98 units

100 archive storage

101 web server

102 conversion, indexing and sorting system cis

103 user interface

104 spooling module

105 conversion module

106 pdf converter

107 recording process correction module

108 conversion module

110 interface

111 data source

112 print server system

1. Method to visually check a print data stream existing in a print data language (AFP, PCL, PS) that is to undergo a print raster process for a point-by-point reproduction on a print device, whereby for visual checking the print data stream undergoes a display raster process that precisely corresponds to the print raster process, and whereby the rastered data of the display raster process are shown on an electronic display medium (monitor, e-paper), whereby to simulate and/or check the print result, in particular to check the registration containment of front and back sides of the recording medium, appertaining data of two pages are respectively shown together and overlaid on the display medium.

2. Method according to claim 1, whereby the display raster process is executed by a raster device whose raster rules conform with the raster rules of the raster device of the print device.

3. Method according to any of the preceding claims, whereby the print raster process is implemented in a raster device arranged in the printer, and the display raster process ensues in a display device physically separate from the printer.

4. Method according to any of the preceding claims, whereby the same print device-specific settings (print width, paper size, fuser oil) are undertaken for the display raster process as for the print raster process.

5. Method according to any of the preceding claims, whereby a recording correction corresponding to further recording parameters is undertaken on the display data before these are displayed.

6. Method according to any of the preceding claims, whereby the print data in any of many possible different print data languages (AFP, LCDS, PCL, PS) are transmitted to a print data production system, undergo the display raster process, then are displayed and checked, transmitted for implementation of the print raster process to a print raster processor, and are then printed out in the print device.

7. Method according to claim (6), whereby the print data production system is functionally coupled with a display program module controlling the display, such that the data processed on the print data production system and/or on the print device are at least job-by-job, in particular page-perfect, simultaneously and automatically on the display program [sic].

8. Method according to claim 7, whereby the display program module automatically invokes a display program (PDV, PDF viewer) when a file rastered in the display raster process is present.

9. Method according to any of the claims 1 through 8, whereby the information pertaining to the back side of a page is shown respectively differentiable from the information pertaining to the front side, in particular distinguished in color.

10. Method according to any of the claims 1 through 9, whereby to check the registration containment of front and back side information, a movable test means is displayed on the display medium.

11. Method according to any of the preceding claims, whereby the print data are processed job-by-job and page-by-page in a print production system and transmitted to a print device, whereby the current page information present in the print device for printing is respectively displayed in a monitoring system.

12. Computer program product that, given its loading and running on a computer, effects a method process according to any of the preceding claims.

13. Print device system with
a raster device (39, 47, 47a, 91) to raster print data for printing on a printer (51-53), a display device (44, 64) to display the rastered print data, and a device (42, 56, 59) to change the print data.

14. Print device system according to claim 13, whereby the raster device (47a) is arranged in a print production system and the display device is provided in a document generation and checking system (40), whereby the document generation and checking system (40) comprises a rastering simulation module (65) that rasters print data according to the same raster rules as the raster device (47).

15. Print device system according to claim 14, whereby the display device (64) comprises a data connection to the rastering simulation module (65) in order to receive and to display the print data rastered by the rastering simulation module (65).

16. Print device system according to claim 14 or 15, whereby the rastering simulation module (65) is a hardware circuit with the same functionality as the raster device (47).

17. Print device system according to claim 14 or 15, whereby the rastering simulation module (65) is a software module with the same functionality as the raster device (47).

18. Print device system according to any of the claims 14 through 17, whereby the rastering simulation module (65) comprises a recording process correction module (107) to correct variations ensuing during the recording process with regard to a predetermined print image.

19. Print device system according to claim 13, whereby an output of the raster device (47) is connected with the display device (44, 56) for transmission of a correction file that comprises the print data rastered by the raster device (47).

20. Print device system according to claim 19, whereby the display device (44) is part of a document generation and checking system (40).

21. Print device system according to claim 19, whereby the display device (56) is part of a print production system (41).

22. Print device system according to any of the claims 19 through 21, whereby the raster device (47) comprises a recording process module (107) to correct variations ensuing during the recording process with regard to a predetermined print image.

23. Print device system according to any of the claims 13 through 22, whereby it is fashioned to implement the method according to any of the claims 1 through 11.
